(19) United States
(12) Patent Application Publication
(10) Pub. No.: US 2026/0313551 A1
(43) Pub. Date: Oct. 8, 2026

(54) DEVICES AND METHODS OF COMMUNICATION

(71) Applicant: NEC CORPPRATION, Tokyo (JP)

(72) Inventors: Rao SHI, Beijing (CN); Lei CHEN, Beijing (CN); Gang WANG, Beijing (CN)

(73) Assignee: NEC CORPPRATION, Tokyo (JP)

(21) Appl. No.: 19/482,304

(22) PCT Filed: May 9, 2023
(86) PCT No.: PCT/CN2023/093007

§ 371 Date: Nov. 7, 2025

(51) Int. Cl. H04W 52/02; H04W 72/231; H04W 76/28

(52) U.S. Cl. CPC H04W 52/0235; H04W 72/231; H04W 76/28

(57) ABSTRACT

Embodiments of the present disclosure relate to devices and methods of communication. In one aspect, upon reception of an LPWUS from a network device, a terminal device performs a PDCCH monitoring before a DRX cycle is started. In this way, a PDCCH monitoring may be performed even if no active time of a DRX cycle is available after reception of an LPWUS, and thus communication latency may be reduced.

### TECHNICAL FIELD

Embodiments of the present disclosure generally relate to the field of telecommunication, and in particular, to methods, devices and computer storage media of communication for a lower-power wake-up signal (LPWUS).

### BACKGROUND

Currently, it has been proposed to use main radio to describe a regular communication device performing normal radio resource control (RRC) states and additionally design an LPWUS receiver to monitor an LPWUS for turn-on of the main radio. When a terminal device is not receiving a service, the terminal device may enter an LPWUS mode during which the main radio is turned off and the LPWUS receiver is turned on to monitor the LPWUS. However, cooperation between an LPWUS mechanism and a discontinuous reception (DRX) mechanism upon reception of an LPWUS is still unclear and needs to be further developed.

### SUMMARY

In general, embodiments of the present disclosure provide methods, devices and computer storage media of communication for an LPWUS.

In a first aspect, there is provided a terminal device. The terminal device comprises a processor configured to cause the terminal device to: receive an LPWUS from a network device; and perform a physical downlink control channel (PDCCH) monitoring before a DRX cycle is started.

In a second aspect, there is provided a terminal device. The terminal device comprises a processor configured to cause the terminal device to: receive an LPWUS from a network device; and enter a connected state at a time offset before an active time of a DRX cycle after reception of the LPWUS.

In a third aspect, there is provided a terminal device. The terminal device comprises a processor configured to cause the terminal device to: transmit, to a network device, assistance information for at least one of an LPWUS configuration or a DRX configuration.

In a fourth aspect, there is provided a method of communication. The method comprises: receiving, at a terminal device, an LPWUS from a network device; and performing a PDCCH monitoring before a DRX cycle is started.

In a fifth aspect, there is provided a method of communication. The method comprises: receiving, at a terminal device, an LPWUS from a network device; and entering a connected state at a time offset before an active time of a DRX cycle after reception of the LPWUS.

In a sixth aspect, there is provided a method of communication. The method comprises: transmitting, at a terminal device and to a network device, assistance information for at least one of an LPWUS configuration or a DRX configuration.

In a seventh aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates an example structure of a terminal device in which some embodiments of the present disclosure can be implemented;

FIG. 1C illustrates a diagram illustrating a LPWUS mechanism in which some embodiments of the present disclosure can be implemented;

FIG. 1D illustrates a schematic diagram of a DRX mechanism in which some embodiments of the present disclosure can be implemented;

FIG. 2 illustrates a schematic diagram illustrating a process of communication according to embodiments of the present disclosure;

FIG. 3A illustrates a schematic diagram illustrating an example PDCCH monitoring based on a timer configured for an active time according to embodiments of the present disclosure;

FIG. 3B illustrates a schematic diagram illustrating an cxample PDCCH monitoring based on a PDCCH configuration according to embodiments of the present disclosure;

FIG. 3C illustrates a schematic diagram illustrating an example PDCCH monitoring based on a short DRX cycle according to embodiments of the present disclosure;

FIG. 3D illustrates a schematic diagram illustrating an example PDCCH monitoring based on a DRX cycle dedicated for an LPWUS mechanism according to embodiments of the present disclosure;

FIG. 4 illustrates a schematic diagram illustrating another process of communication according to embodiments of the present disclosure;

FIG. 5 illustrates a schematic diagram illustrating an example operation based on an active time of a DRX cycle according to embodiments of the present disclosure;

FIG. 6 illustrates a schematic diagram illustrating still another process of communication according to embodiments of the present disclosure;

FIG. 7 illustrates an example method of communication implemented at a terminal device in accordance with some embodiments of the present disclosure;

FIG. 8 illustrates another example method of communication implemented at a terminal device in accordance with some embodiments of the present disclosure;

FIG. 9 illustrates still another example method of communication implemented at a terminal device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

In the context of the present disclosure, the term “a LPWUS cycle” may refer to a cycle for monitoring an LPWUS and the term “a DRX cycle” may refer to a cycle for monitoring a PDCCH. In the context of the present disclosure, the term “turn on” may be interchangeably used with “wake up”, “switch on”, “state transition” or “warm up”. In the context of the present disclosure, the term “always-on monitoring” may be interchangeably used with “continuous monitoring”, and the term “duty-cycle monitoring” may be interchangeably used with “periodic monitoring”. In the context of the present disclosure, the term “a DRX cycle” may be interchangeably used with “a long DRX cycle” or “a legacy DRX cycle” or “a normal DRX cycle”.

In general, the fifth generation (5G) devices consume tens of milliwatts in RRC idle or inactive state and hundreds of milliwatts in RRC connected state. Designing to prolong battery life is a necessity for improving energy efficiency as well as for better user experience. To meet the battery life requirements, an enhanced discontinuous reception (eDRX) cycle with a large value is expected to be used. The eDRX cycle may result in high latency and thus is not suitable for services with requirements of both long battery life and low latency. For example, in fire detection and extinguishment use case, a long eDRX cycle cannot meet the delay requirements. That is, eDRX is apparently not suitable for latency-critical use cases. Thus, it is expected to study an ultra-low power mechanism that can support low latency, e.g., lower than eDRX latency.

An LPWUS mechanism has been proposed as the ultra-low power mechanism. In the LPWUS mechanism, when a terminal device is not receiving a service, the terminal device may enter an LPWUS mode during which main radio is turned off and an LPWUS receiver is turned on to monitor an LPWUS. However, it is still unclear how to cooperate between an LPWUS mechanism and a DRX mechanism upon reception of an LPWUS.

Embodiments of the present disclosure provide solutions of communication so as to facilitate cooperation between an LPWUS mechanism and a DRX mechanism. In one aspect, upon reception of an LPWUS from a network device, a terminal device performs a PDCCH monitoring before a DRX cycle is started. In this way, a PDCCH monitoring may be performed even if no active time of a DRX cycle is available after reception of an LPWUS, and thus communication latency may be reduced.

In another aspect, upon reception of an LPWUS from a network device, a terminal device enters a connected state at a time offset before an active time of a DRX cycle after reception of the LPWUS. In this way, a terminal device may delay to enter a connected state after reception of the LPWUS and thus achieve power saving.

In still another aspect, a terminal device transmits, to a network device, assistance information for at least one of an LPWUS configuration or a DRX configuration. In this way, better network adjustment or implementation for the LPWUS or DRX configuration may be facilitated and thus an optimized LPWUS or DRX configuration may be provided.

Principles and implementations of the present disclosure will be described in detail below with reference to the figures.

### Example of Communication Network

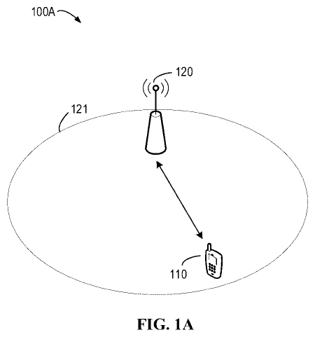

FIG. 1A illustrates a schematic diagram of an example communication network 100A in which some embodiments of the present disclosure can be implemented. As shown in FIG. 1A, the communication network 100A may comprise a terminal device 110 and network device 120. The network device 120 may provide a serving cell (also referred to as a cell herein) 121 to serve one or more terminal devices. In this example, the terminal device 110 is shown as being located in the cell 121 and served by the network device 120.

As shown in FIG. 1A, the terminal device 110 and the network device 120 may communicate with each other via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices or cells in FIG. 1A is given for the purpose of illustration without suggesting any limitations to the present disclosure. The communication network 100A may include any suitable number of network devices and/or terminal devices and/cells adapted for implementing implementations of the present disclosure.

FIG. 1B illustrates a diagram 100B illustrating an example structure of a terminal device in which some embodiments of the present disclosure can be implemented. For convenience, FIG. 1B is described in connection with the terminal device 110 of FIG. 1A.

As shown in FIG. 1B, the terminal device 110 may comprise a LPWUS receiver 141 and main radio 142. The LPWUS receiver 141 is configured to monitor a LPWUS. The main radio 142 is configured as a regular communication device performing normal RRC states.

In some embodiments, the LPWUS receiver 141 may detect the LPWUS indicating turn-off of the main radio 142, and trigger the main radio 142 to enter a turn-off or deep-sleep state. In the turn-off or deep-sleep state, the terminal device 110 is not required to process an idle or inactive or connected state procedure. In some embodiments, the LPWUS receiver 141 may detect the LPWUS indicating turn-on of the main radio 142, and trigger the main radio 142 to enter a turn-on state. In some embodiments for the idle or inactive state, the main radio 142 in the turn-on state may monitor paging occasions (POS). In some embodiments for the connected state, the main radio 142 in the turn-on state may perform a random access (RA) procedure or monitor PDCCH occasions.

FIG. 1C illustrates a diagram 100C illustrating a LPWUS mechanism in which some embodiments of the present disclosure can be implemented. For convenience, FIG. 1C is described in connection with FIG. 1B. In this example, the turn-on state of the main radio 142 corresponds to a connected state of the terminal device 110. As shown in FIG. 1C, when the terminal device 110 enters a LPWUS mode, the LPWUS receiver 141 may turn on and the main radio 142 may not monitor PDCCH occasions. When the LPWUS receiver 141 detects a LPWUS (for example, WUS=1) indicating turn-on of the main radio 142, the LPWUS receiver 141 triggers the main radio 142 to turn on and the LPWUS receiver 141 turns off. In this case, the main radio 142 may start monitoring PDCCH occasions 151. Alternatively, upon RA completion, the main radio 142 may start monitoring the PDCCH occasions 151.

In some embodiments, the network device 120 may transmit a DRX configuration to the terminal device 110. The terminal device 110 in a connected state may perform PDCCH monitoring based on the DRX configuration. In some embodiments, the DRX configuration may indicate a DRX cycle. FIG. 1D illustrates a schematic diagram 100D of a DRX mechanism in which some embodiments of the present disclosure can be implemented. As shown by a reference sign 160 in FIG. 1D, a DRX cycle may comprise on duration time and sleep time. A terminal device may perform PDCCH monitoring during the on duration time, and may not perform the PDCCH monitoring during the sleep time.

In some scenarios, a network device may transmit 161 downlink control information (DCI) via a PDCCH during the on duration time. In this case, the terminal device may receive the DCI by monitoring the PDCCH. In some scenarios, the network device may transmit 162 DCI via a PDCCH during the sleep time. In this case, the terminal device cannot receive the DCI. The network device may receive a negative acknowledgement (NACK) for the DCI reception and then wait for next active time of the terminal device to transmit 163 the DCI via the PDCCH during the next active time.

As shown by a reference sign 170 in FIG. 1D, a long DRX cycle may be configured, and an on-duration timer may be started according to the long DRX cycle. As shown by a reference sign 180 in FIG. 1D, a short DRX cycle may also be configured. If data is received during running of the on-duration timer, an inactivity timer (IAT) may be started. If the IAT expires, a short DRX cycle timer may be started. If the short DRX cycle timer expires, the long DRX cycle timer may be used.

As shown by a reference sign 190 in FIG. 1D, if data is received during running of the on-duration timer, the IAT may be started. In some scenarios, a command for DRX in a medium access control control element (MAC CE) (i.e., DRX command MAC CE) may be received during running of the IAT. Upon reception of the DRX command MAC CE, a short DRX cycle timer may be started. When the short DRX cycle timer expires, the long DRX cycle timer may be used.

It can be seen that according to the DRX mechanism, a terminal device may only receive data on PDCCH during active time of a DRX cycle. If there is no active time available when the terminal device detects an LPWUS and turns on main radio of the terminal device, reception of the data will be delayed until next DRX cycle, and thus data latency will be increased. In addition, a relationship between LPWUS monitoring occasions and DRX cycles is unclear.

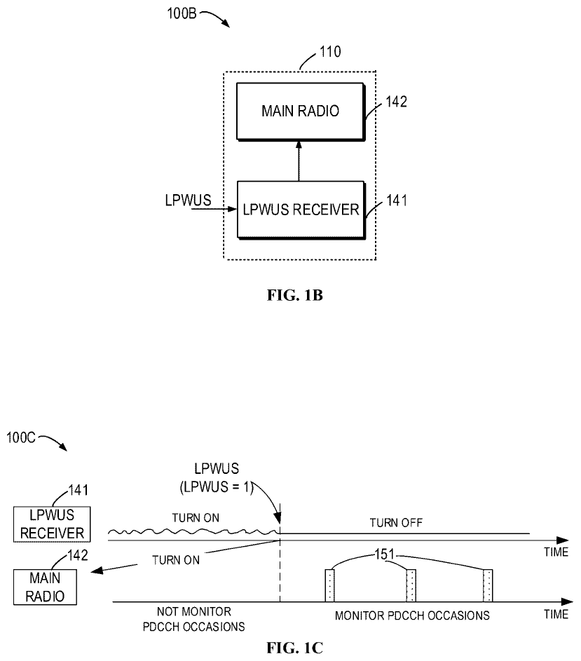

Embodiments of the present disclosure provide solutions of communication so as to so as to overcome the above and other potential issues. These solutions will be described with reference to FIGS. 2 to 9 below.

### Example Implementation of PDCCH Monitoring Before Start of DRX Cycle

FIG. 2 illustrates a schematic diagram illustrating a process 200 of communication according to embodiments of the present disclosure. For the purpose of discussion, the process 200 will be described with reference to FIGS. 1A and 1B. The process 200 may involve the terminal device 110 and the network device 120 as illustrated in FIG. 1A. It is to be understood that the steps and the order of the steps in FIG. 2 are merely for illustration, and not for limitation. For example, the order of the steps may be changed. Some of the steps may be omitted or any other suitable additional steps may be added. It is assumed that the terminal device 110 is in an LPWUS mode initially.

As shown in FIG. 2, the network device 120 may transmit 210, to the terminal device 110, a DRX configuration and an LPWUS configuration. The DRX configuration may be applied by the main radio 142. The LPWUS configuration may be applied by the LPWUS receiver 141. For example, the DRX configuration may indicate a DRX cycle. The LPWUS configuration may indicate a LPWUS cycle. It is to be understood that the DRX configuration and the LPWUS configuration may further comprise any other suitable information.

The terminal device 110 (e.g., the LPWUS receiver 141) may perform an LPWUS monitoring based on the LPWUS cycle. With reference to FIG. 2, the terminal device 110 may receive 220 an LPWUS from the network device 120.

Upon reception of the LPWUS, the terminal device 110 may perform 230 a PDCCH monitoring before a DRX cycle (i.e., legacy or normal DRX cycle) is started. In other words, the terminal device 110 will perform a PDCCH monitoring even if the DRX cycle is not started (i.e., there is no active time of a DRX cycle). For illustration, some example embodiments will be described in connection with Embodiments 1 to 4 below.

### Embodiment 1

With reference to FIG. 2, in this embodiment, upon reception of the LPWUS, the terminal device 110 may start 231 a timer (denoted as drx-onDuration Timer-LPWUS herein) configured for an active time during which the PDCCH monitoring is performed. In other words, a dedicated or new active time is introduced for the PDCCH monitoring before start of the DRX cycle. It is to be noted that the terminal device 110 receives the LPWUS in the LPWUS mode and starts the timer drx-onDurationTimer-LPWUS in a connected state.

In some embodiments, a value of the timer may be predefined. In some embodiments, the value of the timer may be preconfigured or configured by the network device 120.

In some embodiments, the terminal device 110 may start the timer when the main radio 142 is turned on. In some embodiments, the terminal device 110 may start the timer when the terminal device 110 enters a connected state. In some embodiments, the terminal device 110 may start the timer at a time offset (denoted as start_offset herein) after the reception of the LPWUS or the turn-on of the main radio or the entering of the connected state. In some embodiments, the time offset may be predefined. In some embodiments, the time offset may be preconfigured or configured by the network device 120.

In some embodiments, if a time offset between the reception of the LPWUS or the turn-on of the main radio or the entering of the connected state and start of the DRX cycle is above (e.g., larger than or equal to) a threshold offset (denoted as threshold_offset herein), the terminal device 110 may start the timer. In some embodiments, the threshold offset may be predefined. In some embodiments, the threshold offset may be preconfigured or configured by the network device 120.

As shown in FIG. 2, the terminal device 110 may perform 232 the PDCCH monitoring during running of the timer. In some embodiments, the terminal device 110 may perform the PDCCH monitoring during running of the timer until the DRX cycle is started. In some embodiments, operations of the PDCCH monitoring during the running of the timer drx-onDuration Timer-LPWUS are similar with that for the DRX cycle. In other words, operations based on an IAT (e.g., drx-InactivityTimer), a retransmission timer (e.g., drx-RetransmissionTimer), a hybrid automatic repeated request (HARQ) round-trip time (RTT) timer (e.g., drx-HARQ-RTT-Timer) or a short DRX cycle (e.g., drx-ShortCycle) may still be used based on PDCCH scheduling within the timer drx-onDurationTimer-LPWUS. For example, when the terminal device 110 receives data (i.e., PDCCH), the IAT drx-InactivityTimer will be started.

In some embodiments, if the time offset between the reception of the LPWUS or the turn-on of the main radio or the entering of the connected state and the start of the DRX cycle is below (e.g., smaller than or equal to) the threshold offset, the terminal device 110 may perform the PDCCH monitoring after the DRX cycle is started. That is, the terminal device 110 may not start the timer drx-onDurationTimer-LPWUS, and may not perform the PDCCH monitoring until the DRX cycle is started. Upon start of the DRX cycle, the terminal device 110 may perform the PDCCH monitoring based on the DRX cycle (i.e., during an active time of the DRX cycle).

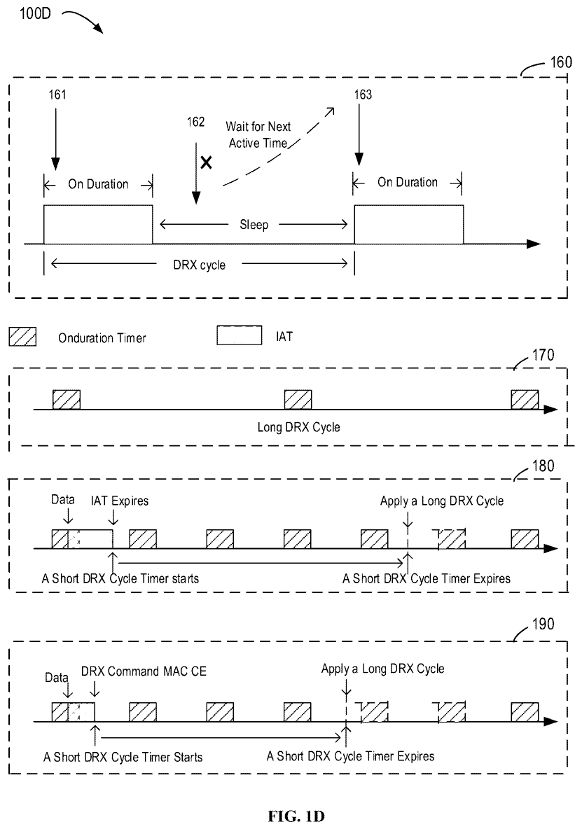

FIG. 3A illustrates a schematic diagram 300A illustrating an example PDCCH monitoring based on a timer configured for an active time according to embodiments of the present disclosure. In an example 310 shown in FIG. 3A, an LPWUS monitoring is in a duty-cycle mode (i.e., periodic monitoring). As shown in FIG. 3A, an LPWUS is received at an LPWUS occasion 311 in an LPWUS mode (e.g., within a connected state or outside of the connected state). As a time offset between reception of the LPWUS (i.e., the LPWUS occasion 311) and start of the next DRX cycle (i.c., active time 312 during running of a timer drx-onDuration Timer) is greater than threshold_offset, a timer drx-onDurationTimer-LPWUS for an active time 313 will be started in the connected state (i.e., main radio is activated) at a time offset start_offset after reception of the LPWUS. PDCCH monitoring will be performed during the active time 313. As shown in FIG. 3A, if data is received at a timing A during the active time 313, and an IAT drx-InactivityTimer is started accordingly at the timing A. The PDCCH monitoring will continue to be performed during running of the IAT.

In an example 320 shown in FIG. 3A, an LPWUS monitoring is in an always-on mode (i.e., continuous monitoring). As shown in FIG. 3A, an LPWUS is received at a timing B in an LPWUS mode (e.g., within a connected state or outside of the connected state). As a time offset between reception of the LPWUS (i.e., the timing B) and start of the next DRX cycle (i.e., active time 321 during running of a timer drx-onDuration Timer) is not greater than threshold_offset, a timer drx-onDurationTimer-LPWUS will not be started before start of the next DRX cycle (active time 321). As shown in FIG. 3A, PDCCH monitoring will not be performed until the active time 321. If data is received at a timing C during the active time 321, and an IAT drx-InactivityTimer is started accordingly at the timing C. PDCCH monitoring will continues to be performed during running of the IAT.

It is to be understood that FIG. 3A is merely an example, and does not limit the present disclosure.

For illustration, an example procedure may be described as below.

When DRX is configured, the Active Time for Serving Cells in a DRX group includes the time while:
drx-onDurationTimer or drx-InactivityTimer or drx-onDurationTimer-LPWUS configured for the DRX group is running;

When DRX is configured, the UE shall:
1> if the UE is in LPWUS mode:
   2> deactivate the RRC_CONNECTED related operations including DRX functionality;
   2> monitor LPWUS based on the LPWUS configuration (e.g., always-on monitoring or duty-cycle monitoring);
1> if UE receives LPWUS that indicate waking up MR/entering RRC_CONNECTED for data (i.e., PDCCH) reception:
   2> if the time offset between the LPWUS reception (or the time that UE wakes up MR/enters RRC_CONENCTED) and start of next DRX cycle (or next legacy drx-onDurationTimer) is greater than threshold_offset:
      3> start drx-onDurationTimer-LPWUS for this DRX group after the end of LPWUS reception (or the time that UE wakes up MR/enters RRC-CONECTED) or after the start-offset;
   2> else (i.e., the time offset is not greater than threshold_offset):
      3> using legacy DRX mechanism based on the calculation of Long DRX cycle after wake up MR/enter RRC_CONNECTED (i.e., not start drx-onDurationTimer-LPWUS).
   2> if time offset mechanism is not configured:
      3> start drx-onDuration Timer-LPWUS for this DRX group after the end of LPWUS reception (or the time that UE wakes up MR/enters RRC-CONECTED) or after the start_offset;
1> if a DRX group is in Active Time:
   2> monitor the PDCCH on the Serving Cells in this DRX group.

In this example, a parameter drx-onDurationTimer-LPWUS denotes a new type of DRX active time and a duration/window that UE shall monitor PDCCH. A reasonable unit of drx-onDurationTimer-LPWUS may be ms. A parameter start-offset denotes a delay before starting drx-onDurationTimer-LPWUS. A reasonable unit of start-offset may be ms or slot. A parameter threshold_offset denotes a criterion used to determine whether the UE shall start drx-onDurationTimer-LPWUS based on the time offset between the LPWUS detection (or the time that UE wakes up main radio/enter a connected state) and start of next DRX cycle (or next drx-onDurationTimer). A reasonable unit of threshold_offset may be ms.

### Embodiment 2

Still with reference to FIG. 2, in this embodiment, upon reception of the LPWUS, the terminal devicc 110 may perform 233 the PDCCH monitoring based on a PDCCH configuration for the terminal device 110. In some embodiments, the terminal device 110 may perform the PDCCH monitoring based on the PDCCH configuration until the DRX cycle is started. In other words, the terminal device 110 may perform the PDCCH monitoring regardless of an active time of a DRX cycle.

In contrast, in a conventional solution, although a PDCCH occasion is configured by a search space and a CORESET in active downlink (DL) bandwidth part (BWP), UE only needs to monitor PDCCH during active time of a DRX cycle. That is to say, the PDCCH configuration is specific location/occasion of PDCCH monitoring and the active time is a monitoring enabled window in the conventional solution.

It is to be noted that the terminal device 110 receives the LPWUS in the LPWUS mode, and performs the PDCCH monitoring based on the PDCCH configuration in a connected state.

In some embodiments, the PDCCH configuration may comprise at least one of a search space or a control resource set (CORESET).

In some embodiments, the terminal device 110 may perform the PDCCH monitoring based on the PDCCH configuration upon turn-on of the main radio. In some embodiments, the terminal device 110 may perform the PDCCH monitoring based on the PDCCH configuration upon entering of the connected state.

In some embodiments, the terminal device 110 may perform the PDCCH monitoring at a time offset (denoted as start_offset herein) after the reception of the LPWUS or the turn-on of the main radio or the entering of the connected state. In some embodiments, the time offset may be predefined. In some embodiments, the time offset may be preconfigured or configured by the network device 120.

In some embodiments, if no active time of a DRX cycle is available upon reception of the LPWUS or the turn-on of the main radio or the entering of the connected state, the terminal device 110 may perform the PDCCH monitoring based on the PDCCH configuration until the next DRX cycle. Upon start of the next DRX cycle, the terminal device 110 may perform the PDCCH monitoring based on the next DRX cycle (i.e., follow a DRX pattern within active time). FIG. 3B illustrates a schematic diagram 300B illustrating an example PDCCH monitoring based on a PDCCH configuration according to embodiments of the present disclosure. In an example 330 shown in FIG. 3B, an LPWUS monitoring is in a duty-cycle mode. As shown in FIG. 3B, an LPWUS is received at an LPWUS occasion 331 in an LPWUS mode (e.g., within a connected state or outside of the connected state). There is no available DRX active time upon reception of the LPWUS. At a time offset start_offset after reception of the LPWUS, the PDCCH monitoring will be performed at PDCCH occasions 332 based on the PDCCH configuration in a connected state. The PDCCH occasions 332 may be within or outside of active time 333 of the next DRX cycle. In this example, data is received on a PDCCH occasion 332-1 outside of the active time 333.

In some embodiments, the LPWUS may be received during an active time of a DRX cycle. In this case, as the terminal device 110 is still in an LPWUS mode when it comes to the start position of active time, an active time of a DRX cycle will not be started by main radio. Thus the terminal device 110 may still perform the PDCCH monitoring based on the PDCCH configuration until the next DRX cycle. Upon start of the next DRX cycle, the terminal device 110 may perform the PDCCH monitoring based on the next DRX cycle (i.e., follow a DRX pattern within active time). With reference to FIG. 3B, in an example 340 shown in FIG. 3B, an LPWUS monitoring is in a duty-cycle mode. As shown in FIG. 3B, an LPWUS is received at an LPWUS occasion 341 in an LPWUS mode (e.g., within a connected state or outside of the connected state). The LPWUS occasion 341 is in an active time of a DRX cycle. At a time offset start_offset after reception of the LPWUS, the PDCCH monitoring will start to be performed at PDCCH occasions 342 based on the PDCCH configuration in a connected state. The PDCCH occasions 342 may be within or outside of active time 343 of the next DRX cycle. In this example, data is received on a PDCCH occasion 342-1 outside of the active time 343.

It is to be understood that FIG. 3B is merely an example, and does not limit the present disclosure.

For illustration, an example procedure may be described as below.

When DRX is configured, the UE shall:
1> if the UE is in LPWUS mode:
   2> deactivate the RRC_CONNECTED related operations including DRX functionality;
   2> monitor LPWUS based on the LPWUS configuration (e.g., always-on monitoring or duty-cycle monitoring);
1> if UE receives LPWUS that indicate waking up MR/entering RRC_CONNECTED for data (i.e., PDCCH) reception:
   2> after the end of LPWUS reception (or the time that UE wake up MR/enter RRC-CONECTED) or after the start_offset, monitor PDCCH on the Serving Cells based on SearchSpace and CORESET (i.e., PDCCH Config) configured with this UE until the start of next DRX cycle (or next legacy drx-onDuration Timer).

In this example, a parameter start-offset denotes a delay before starting to monitor PDCCH. A reasonable unit of start-offset may be ms or slot or symbol.

### Embodiment 3

Still with reference to FIG. 2, in this embodiment, upon reception of the LPWUS, the terminal device 110 may start 234 a short DRX cycle associated with the DRX cycle (i.e., a long DRX cycle). That is, a new usage of a short DRX cycle is introduced. In this case, a short DRX cycle may be started upon expiration of an IAT or upon reception of a DRX command MAC CE or upon reception of an LPWUS.

In some embodiments, the terminal device 110 may start the short DRX cycle upon turn-on of the main radio. In some embodiments, the terminal device 110 may start the short DRX cycle upon entering of the connected state.

In some embodiments, the terminal device 110 may start the short DRX cycle at a time offset (denoted as start_offset herein) after the reception of the LPWUS or the turn-on of the main radio or the entering of the connected state. In some embodiments, the time offset may be predefined. In some embodiments, the time offset may be preconfigured or configured by the network device 120.

In some embodiments, starting a short DRX cycle means that a short DRX cycle timer is started and DRX active time is started based on calculation of the short DRX cycle during running of the short DRX cycle timer.

Then the terminal device 110 may perform 235 the PDCCH monitoring based on the short DRX cycle. In some embodiments, the terminal device 110 may perform the PDCCH monitoring based on the short DRX cycle until the DRX cycle is started. In some embodiments, operations of the PDCCH monitoring during the short DRX cycle are similar with that for the DRX cycle. In other words, operations based on an IAT (e.g., drx-InactivityTimer), a retransmission timer (e.g., drx-RetransmissionTimer), a hybrid automatic repeated request (HARQ) round-trip time (RTT) timer (c.g., drx-HARQ-RTT-Timer) or a short DRX cycle (e.g., drx-ShortCycle) may still be used based on PDCCH scheduling. For example, when the terminal device 110 receives data (i.e., PDCCH), the IAT will be started. When the IAT expiries, a short DRX cycle timer will be started or restarted. When the short DRX cycle timer expires, a long DRX cycle may be used based on calculation of the long DRX cycle.

It is to be noted that the terminal device 110 receives the LPWUS in the LPWUS mode, and starts the short DRX cycle in a connected state.

FIG. 3C illustrates a schematic diagram 300C illustrating an example PDCCH monitoring based on a short DRX cycle according to embodiments of the present disclosure. As shown in FIG. 3C, an LPWUS monitoring is in a duty-cycle mode. An LPWUS is received at an LPWUS occasion 351 in an LPWUS mode (e.g., within a connected state or outside of the connected state). At a time offset start_offset after reception of the LPWUS, a short DRX cycle is started or used in a connected state, i.e., a short DRX cycle timer (e.g., drx-ShortCycleTimer) is started. The PDCCH monitoring will be performed within active time 352. In this example, data is received on a timing D, and an IAT drx-InactivityTimer is started accordingly at the timing D. PDCCH monitoring will continues to be performed during running of the IAT. When the IAT expires, the short DRX cycle timer is restarted.

It is to be understood that FIG. 3C is merely an example, and does not limit the present disclosure.

For illustration, an example procedure may be described as below.

When DRX is configured, the UE shall:
1> if the UE is in LPWUS mode:
   2> deactivate the RRC_CONNECTED related operations including DRX functionality;
   2> monitor LPWUS based on the LPWUS configuration (e.g., always-on monitoring or duty-cycle monitoring);
1> if the UE receives LPWUS that indicate waking up MR/entering RRC_CONNECTED for data (i.e., PDCCH) reception:
   2> if the Short DRX cycle is configured:
      3> start drx-ShortCycleTimer for this DRX group after the end of LPWUS reception (or the time that UE wakes up MR/enters RRC_CONECTED) or after the start-offset;
      3> Use the Short DRX Cycle for this DRX group.
   2> clsc:
      3> Use the Long DRX cycle for this DRX group.

In this example, a parameter start-offset denotes a delay before starting to monitor PDCCH. A reasonable unit of start-offset may be ms or slot or symbol.

For illustration, an example procedure of using the short DRX cycle may be described as below.
1> if the Short DRX cycle is used for a DRX group, and [(SFN×10)+subframe number] modulo (drx-ShortCycle)=(drx-StartOffset) modulo (drx-ShortCycle):
   2> start drx-onDurationTimer for this DRX group after drx-SlotOffset from the beginning of the subframe.
1> if drx-ShortCycleTimer for a DRX group expires:
   2> use the Long DRX cycle for this DRX group.
1> if a DRX group is in Active Time:
   2> monitor the PDCCH on the Serving Cells in this DRX group.

### Embodiment 4

Still with reference to FIG. 2, in this embodiment, upon reception of the LPWUS, the terminal device 110 may start 236 a further DRX cycle dedicated for LPWUS. That is, a separate DRX configuration is introduced.

In some embodiments, the terminal device 110 may receive, from the network device 120, a configuration for the further DRX cycle. In some embodiments, the configuration may comprise an indication of a location where the further DRX cycle starts. In some embodiments, the configuration may comprise information of a long DRX cycle (e.g., drx-LongCycle′) and an offset (e.g., drx-StartOffset′) to define a subframe or slot or symbol where the further DRX cycle starts. In some embodiments, the further DRX cycle may be shorter than the DRX cycle (i.e., the legacy or normal DRX cycle).

In some embodiments, the configuration may comprise an indication (e.g., drx-onDurationTimer′) of a duration of an active time of the further DRX cycle. In some embodiments, the duration of the active time of the further DRX cycle may be shorter than that of the legacy or normal DRX cycle.

In some embodiments, the configuration may comprise an indication (e.g., drx-InactivityTimer′) of a duration of the active time after an occasion in which a transmission (e.g., an UL or DL transmission) is indicated. In some embodiments, the duration of the active time for the further DRX cycle may be shorter than that for the legacy or normal DRX cycle. It is to be understood that the configuration may comprise any combination of the above information or any other suitable information.

In some embodiments, the terminal device 110 may start a further DRX cycle dedicated for LPWUS upon turn-on of the main radio. In some embodiments, the terminal device 110 may start a further DRX cycle dedicated for LPWUS upon entering of the connected state.

In some embodiments, the terminal device 110 may start the further DRX cycle at a time offset (denoted as start_offset herein) after the reception of the LPWUS or the turn-on of the main radio or the entering of the connected state. In some embodiments, the time offset may be predefined. In some embodiments, the time offset may be preconfigured or configured by the network device 120.

It is to be noted that the terminal device 110 receives the LPWUS in the LPWUS mode, and starts the further DRX cycle in a connected state.

Then the terminal device 110 may perform 237 the PDCCH monitoring based on the further DRX cycle. In some embodiments, the terminal device 110 may perform 237 the PDCCH monitoring based on the further DRX cycle until the legacy or normal DRX cycle is started.

FIG. 3D illustrates a schematic diagram 300D illustrating an example PDCCH monitoring based on a DRX cycle dedicated for an LPWUS mechanism (i.e., LPWUS specific DRX cycle) according to embodiments of the present disclosure. As shown in FIG. 3D, an LPWUS monitoring is in a duty-cycle mode. An LPWUS is received at an LPWUS occasion 361 in an LPWUS mode (e.g., within a connected state or outside of the connected state). At a time offset start_offset after reception of the LPWUS, a LPWUS specific DRX cycle is started or used in a connected state. The PDCCH monitoring will be performed within LPWUS specific active time 362. In this example, data is received on a timing E, and an LPWUS specific IAT is started accordingly at the timing E. PDCCH monitoring will continues to be performed during running of the LPWUS specific IAT.

It is to be understood that FIG. 3D is merely an example, and does not limit the present disclosure.

For illustration, an example procedure may be described as below.

When DRX is configured, the Active Time for Serving Cells in a DRX group includes the time while:
drx-onDuration Timer or drx-onDurationTimer′ or drx-InactivityTimer′ configured for the DRX group is running;

When DRX is configured, the UE shall:
1> if the UE is in LPWUS mode:
   2> deactivate the RRC_CONNECTED related operations including DRX functionality;
   2> monitor LPWUS based on the LPWUS configuration (e.g., always-on monitoring or duty-cycle monitoring);
1> if the UE receives LPWUS that indicate waking up MR/entering RRC_CONNECTED for data (i.e., PDCCH) reception:
   2> if the LPWUS specific DRX is configured:
      3> use the LPWUS specific DRX for this DRX group after the end of LPWUS reception (or the time that UE wakes up MR/enters RRC-CONECTED) or after the start-offset until the start of next normal (legacy) DRX cycle.
   2> else:
      3> use the (legacy) Long DRX cycle for this DRX group.
1> if the LPWUS specific DRX is used for a DRX group, and [(SFN×10)+subframe number] modulo (drx-LongCycle′)=drx-StartOffset′:
   2> start drx-onDuration Timer′ (after drx-SlotOffset′) from the beginning of the subframe;
1> if a DRX group is in Active Time:
   2> monitor the PDCCH on the Serving Cells in this DRX group.

With the process 200, a PDCCH monitoring may be performed before start of a DRX cycle, and thus data latency may be reduced.

### Example Implementation of Entering a Connected State Upon LPWUS Reception

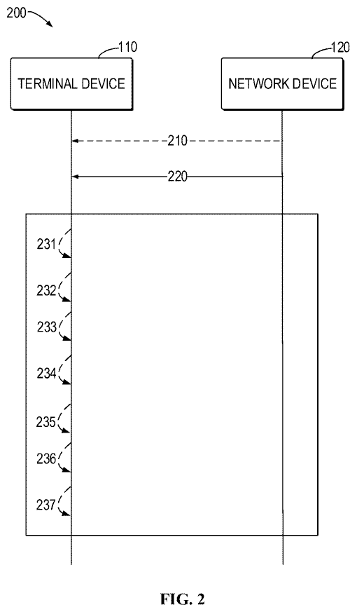

FIG. 4 illustrates a schematic diagram illustrating another process 400 of communication according to embodiments of the present disclosure. For the purpose of discussion, the process 400 will be described with reference to FIG. 1A. The process 400 may involve the terminal device 110 and the network device 120 as illustrated in FIG. 1A. It is to be understood that the steps and the order of the steps in FIG. 4 are merely for illustration, and not for limitation. For example, the order of the steps may be changed. Some of the steps may be omitted or any other suitable additional steps may be added. It is assumed that the terminal device 110 is in an LPWUS mode initially.

As shown in FIG. 4, the network device 120 may transmit 410, to the terminal device 110, a DRX configuration and an LPWUS configuration. The DRX configuration may be applied by the main radio 142. The LPWUS configuration may be applied by the LPWUS receiver 141. For example, the DRX configuration may indicate a DRX cycle. The LPWUS configuration may indicate a LPWUS cycle. It is to be understood that the DRX configuration and the LPWUS configuration may further comprise any other suitable information.

The terminal device 110 (e.g., the LPWUS receiver 141) may perform an LPWUS monitoring based on the LPWUS cycle. With reference to FIG. 4, the terminal device 110 may receive 420 an LPWUS from the network device 120.

Upon reception of the LPWUS, the terminal device 110 may enter 430 a connected state at a time offset before an active time of a DRX cycle after reception of the LPWUS. In other words, the terminal device 110 will remain in the LPWUS mode until the time offset, or will not activate or wake up the main radio until the time offset. In some embodiments, the time offset may be predefined. In some embodiments, the time offset may be preconfigured or configured by the network device 120.

In some embodiments, the terminal device 110 may cancel an LPWUS monitoring after reception of the LPWUS and before entering of the connected state. In this way, power consumption on LPWUS reception may be saved.

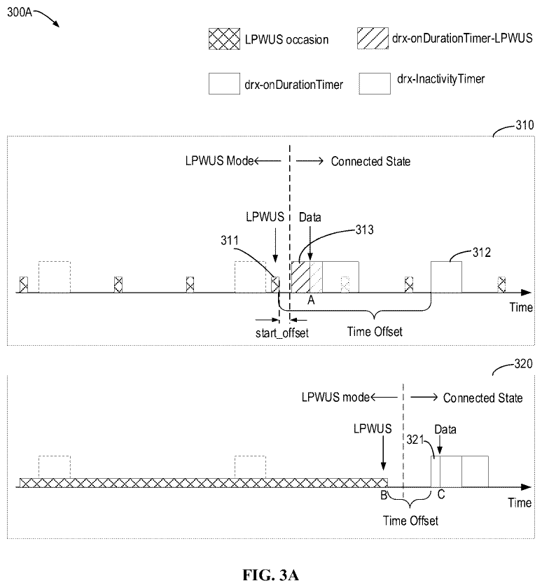

FIG. 5 illustrates a schematic diagram 500 illustrating an example operation based on an active time of a DRX cycle according to embodiments of the present disclosure. For purpose of discussion, this example will be described in connection with FIGS. 1A and 1B. As shown in FIG. 5, an LPWUS monitoring is in a duty-cycle mode. An LPWUS is received at an LPWUS occasion 510 in an LPWUS mode (e.g., within a connected state or outside of the connected state). The terminal device 110 may determine a timing F based on a time offset before active time of a DRX cycle, and enter a connected state or wake up the main radio 142 at the timing F. In other words, the terminal device 110 may delay entering the connected state until the timing F. During the delay, the terminal device 110 may cancel the LPWUS monitoring, e.g., at the LPWUS occasion 511. After entering the connected state, the terminal device 110 may perform a PDCCH monitoring based on the DRX cycle. Data may be received during active time of the DRX cycle.

It is to be understood that FIG. 5 is merely an example, and does not limit the present disclosure.

For illustration, an example procedure may be described as below.

If UE receives the LPWUS that indicates activate/wake up the main radio (or enter RRC_CONNECTED), when there is no DRX Active Time available, UE could delay the procedure of activate/wake up the main radio (or enter RRC_CONNECTED).

If UE receives LPWUS and confirm it, UE will not receive LPWUS during the delay.

With the process 400, entering of a connected state may be delayed and thus power saving may be achieved.

### Example Implementation of LPWUS or DRX Information Report

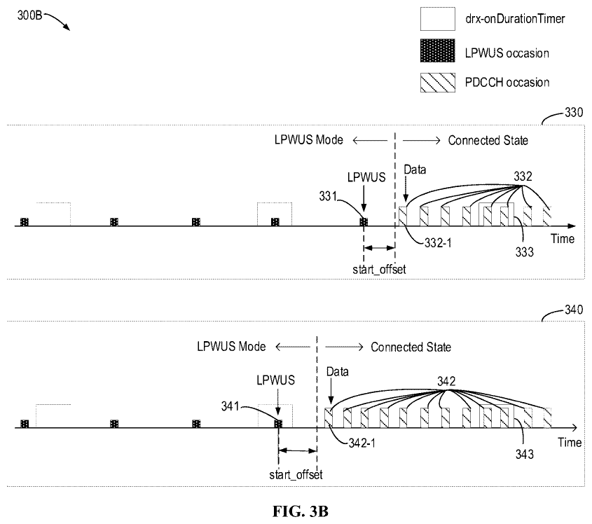

FIG. 6 illustrates a schematic diagram illustrating still another process 600 of communication according to embodiments of the present disclosure. For the purpose of discussion, the process 600 will be described with reference to FIGS. 1A and 1B. The process 600 may involve the terminal device 110 and the network device 120 as illustrated in FIG. 1A. It is to be understood that the steps and the order of the steps in FIG. 6 are merely for illustration, and not for limitation. For example, the order of the steps may be changed. Some of the steps may be omitted or any other suitable additional steps may be added.

As shown in FIG. 6, the terminal device 110 may determine 610 assistance information for at least one of an LPWUS configuration or a DRX configuration.

In some embodiments, the assistance information may comprise a duration (denoted as Gap_LPWUS herein) that the terminal device 110 expects to wake up the main radio 142 of the terminal device 110. A reasonable unit of the duration Gap_LPWUS may be ms or any other suitable time units.

In some embodiments, the assistance information may comprise a preferred monitoring mode of an LPWUS cycle for the terminal device 110. In some embodiments, the preferred monitoring mode may be always-on monitoring. In some embodiments, the preferred monitoring mode may be duty-cycle monitoring. It is to be understood that any other suitable monitoring modes are also feasible.

In some embodiments, the assistance information may comprise a preferred LPWUS cycle for the terminal device 110. In some embodiments, if a cycle is used, the terminal device 110 may indicate an LPWUS cycle preferred by the terminal device 110.

In some embodiments, the assistance information may comprise a preferred time offset for starting an LPWUS monitoring in an LPWUS cycle, e.g., a time offset before starting an LPWUS monitoring in every LPWUS cycle. In some embodiments, if a cycle is used, the terminal device 110 may indicate the time offset preferred by the terminal device 110.

In some embodiments, the assistance information may comprise a preferred time offset (denoted as preferred drx-StartOffset herein) for starting a DRX cycle. The preferred drx-StartOffset may be used to define a subframe where long and short DRX cycle start. In some embodiments, a reasonable unit of the preferred drx-StartOffset is multiples of Ims or any other suitable time units.

In some embodiments, the assistance information may comprise a preferred slot offset (denoted as preferred drx-SlotOffset herein) for starting an on-duration timer (e.g., drx-onDuration Timer) of the DRX cycle. The preferred drx-SlotOffset may be used to define a delay before starting the on-duration timer. In some embodiments, a reasonable unit of the preferred drx-SlotOffset is 1/32 ms or any other suitable time units.

In some embodiments, the assistance information may comprise a preferred length (denoted as preferred drx-onDurationTimer herein) of the on-duration timer of the DRX cycle. The preferred drx-onDurationTimer may be used to define a duration (i.e., active time) that the terminal device 110 monitors a PDCCH. In some embodiments, the preferred drx-onDuration Timer may include drx-onDurationTimer-LPWUS as described in Embodiment 1.

It is to be understood that the assistance information may comprise any combination of the above information or any other suitable information.

Continue to refer to FIG. 6, the terminal device 110 may transmit 620 the assistance information to the network device 120.

In some embodiments, if a timer (also referred to as a prohibit timer herein) configured for prohibiting transmission of the assistance information is not running, the terminal device 110 may transmit the assistance information. In some embodiments, if the assistance information is transmitted, the terminal device 110 may start the timer. In other words, the prohibit timer will be started every time when the terminal device 110 initiates a transmission of assistance information, and the terminal device 110 cannot re-initiate a transmission of assistance information while the prohibit timer is running.

In some embodiments, the terminal device 110 may transmit the assistance information via an RRC message, for example, a UEAssistanceInformation message or a UECapabilityInformation message. Of course, any other suitable messages are also feasible.

With reference to FIG. 6, the network device 120 may adjust 630 the LPWUS configuration and/or the DRX configuration based on the assistance information.

With the process 600, network adjustment or implementation on the LPWUS configuration and/or the DRX configuration may be facilitated.

It is to be understood that operations in the processes 200, 400 and 600 may be carried out separately or in any suitable combination.

### Example Implementation of Methods

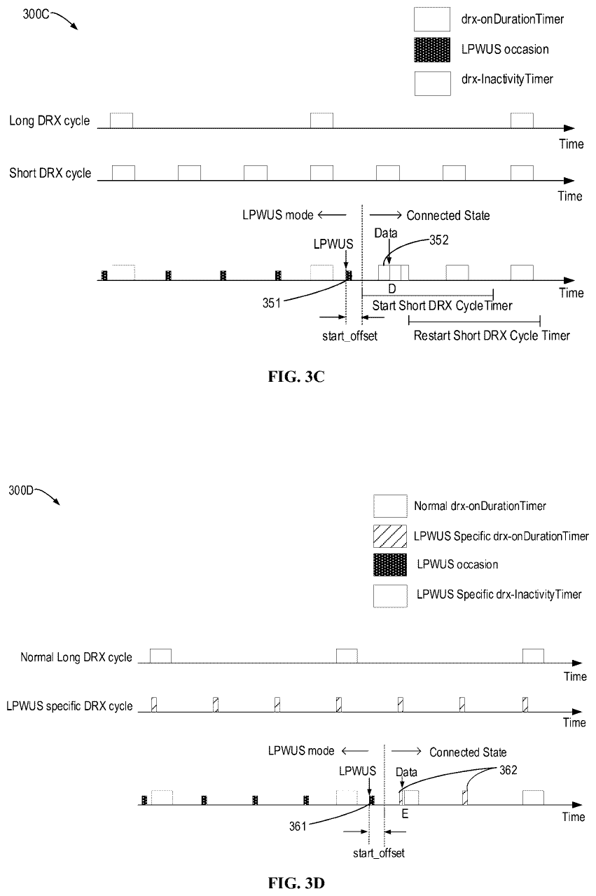

Corresponding to the above processes, embodiments of the present disclosure provide methods of communication implemented at a terminal device. These methods will be described below with reference to FIGS. 7 to 9.

FIG. 7 illustrates an example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 receives an LPWUS from the network device 120.

At block 720, the terminal device 110 performs a PDCCH monitoring before a DRX cycle is started.

In some embodiments, if the LPWUS is received, the terminal device 110 may start a timer configured for an active time during which the PDCCH monitoring is performed, and perform the PDCCH monitoring during running of the timer. In some embodiments, if a time offset between reception of the LPWUS and start of the DRX cycle is above a threshold offset, the terminal device 110 may start the timer. In some embodiments, the terminal device 110 may start the timer at a time offset after the reception of the LPWUS. In some embodiments, if the time offset between the reception of the LPWUS and the start of the DRX cycle is below the threshold offset, the terminal device 110 may perform the PDCCH monitoring after the DRX cycle is started.

In some embodiments, if the LPWUS is received, the terminal device 110 may perform the PDCCH monitoring based on a PDCCH configuration for the terminal device. In some embodiments, the PDCCH configuration may comprise at least one of a search space or a control resource set. In some embodiments, the terminal device 110 may perform the PDCCH monitoring based on the PDCCH configuration at a time offset after the reception of the LPWUS.

In some embodiments, if the LPWUS is received, the terminal device 110 may start a short DRX cycle associated with the DRX cycle, and perform the PDCCH monitoring based on the short DRX cycle. In some embodiments, the terminal device 110 may start the short DRX cycle at a time offset after the reception of the LPWUS.

In some embodiments, if the LPWUS is received, the terminal device 110 may start a further DRX cycle dedicated for LPWUS, and perform the PDCCH monitoring based on the further DRX cycle. In some embodiments, the terminal device 110 may receive, from the network device 120, a configuration for the further DRX cycle. In some embodiments, the configuration for the further DRX cycle may comprise at least one of the following: an indication of a location where the further DRX cycle starts; an indication of a duration of an active time of the further DRX cycle; or an indication of a duration of the active time after an occasion in which a transmission is indicated. In some embodiments, the terminal device 110 may start the further DRX cycle at a time offset after the reception of the LPWUS.

With the method 700, a PDCCH monitoring may be performed before start of a DRX cycle, and thus data latency may be reduced.

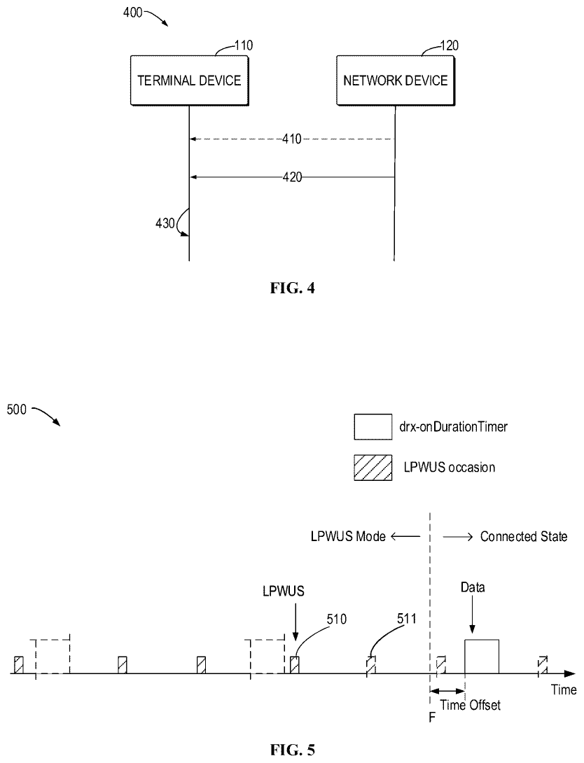

FIG. 8 illustrates another example method 800 of communication implemented at a terminal device in accordance with some embodiments of the present disclosure. For example, the method 800 may be performed at the terminal device 110 as shown in FIG. 1A. It is to be understood that the method 800 may include additional blocks not shown and/or may omit some blocks as shown, and the scope of the present disclosure is not limited in this regard.

At block 810, the terminal device 110 receives an LPWUS from the network device 120.

At block 820, the terminal device 110 enters a connected state at a time offset before an active time of a DRX cycle after reception of the LPWUS.

In some embodiments, the terminal device 110 may cancel an LPWUS monitoring after reception of the LPWUS and before entering of the connected state.

With the method 800, entering of a connected state may be delayed and thus power saving may be achieved.

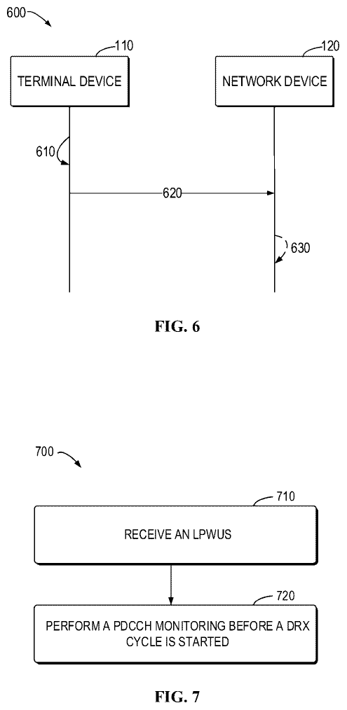

FIG. 9 illustrates another example method 900 of communication implemented at a terminal device in accordance with some embodiments of the present disclosure. For example, the method 900 may be performed at the terminal device 110 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard.

At block 910, the terminal device 110 transmits, to the network device 120, assistance information for at least one of an LPWUS configuration or a DRX configuration.

In some embodiments, if a timer configured for prohibiting transmission of the assistance information is not running, the terminal device 110 may transmit the assistance information. In some embodiments, if the assistance information is transmitted, the terminal device 110 may start the timer.

In some embodiments, the assistance information may comprise at least one of the following: a duration that the terminal device 110 expects to wake up a main radio of the terminal device 110; a preferred monitoring mode of an LPWUS cycle for the terminal device 110; a preferred LPWUS cycle for the terminal device 110; a preferred time offset for starting an LPWUS monitoring in an LPWUS cycle; a preferred time offset for starting a DRX cycle; a preferred slot offset for starting an on-duration timer of the DRX cycle; or a preferred length of the on-duration timer of the DRX cycle.

In some embodiments, the terminal device 110 may transmit the assistance information via an RRC message.

With the method 900, network adjustment or implementation on the LPWUS configuration and/or the DRX configuration may be facilitated.

It is to be understood that operations of the methods 700 to 900 correspond to the processes described in connection with FIGS. 2 to 6, and thus other details are omitted here for concise.

### Example Implementation of Devices

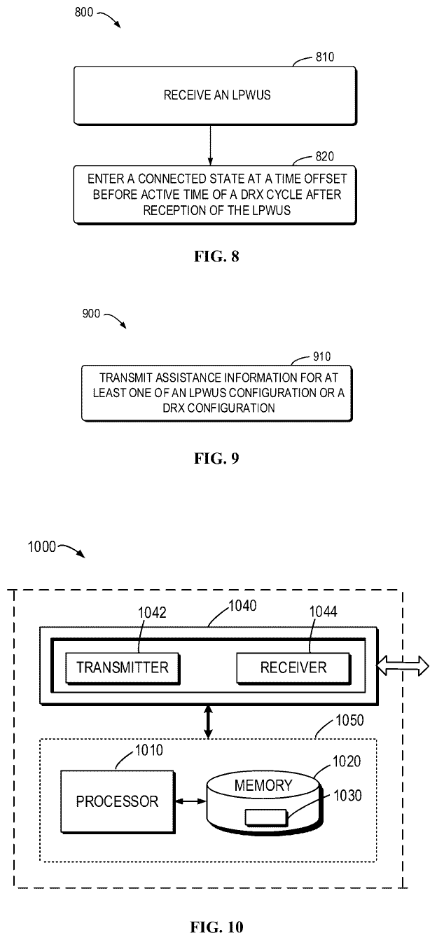

FIG. 10 is a simplified block diagram of a device 1000 that is suitable for implementing embodiments of the present disclosure. The device 1000 can be considered as a further example implementation of the terminal device 110 or the network device 120 as shown in FIG. 1A. Accordingly, the device 1000 can be implemented at or as at least a part of the terminal device 110 or the network device 120.

As shown, the device 1000 includes a processor 1010, a memory 1020 coupled to the processor 1010, a suitable transceiver 1040 coupled to the processor 1010, and a communication interface coupled to the transceiver 1040. The memory 1010 stores at least a part of a program 1030. The transceiver 1040 may be for bidirectional communications or a unidirectional communication based on requirements. The transceiver 1040 may include at least one of a transmitter 1042 or a receiver 1044. The transmitter 1042 and the receiver 1044 may be functional modules or physical entities. The transceiver 1040 has at least one antenna to facilitate communication, though in practice an Access Node mentioned in this application may have several ones. The communication interface may represent any interface that is necessary for communication with other network clements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1A to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: receive an LPWUS from a network device; and perform a PDCCH monitoring before a DRX cycle is started.

In some embodiments, a terminal device comprises a circuitry configured to: receive an LPWUS from a network device; and enter a connected state at a time offset before an active time of a DRX cycle after reception of the LPWUS.

In some embodiments, a terminal device comprises a circuitry configured to: transmit, to a network device, assistance information for at least one of an LPWUS configuration or a DRX configuration.

The term “circuitry” used hercin may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method performed by a terminal device, comprising:
receiving a discontinuous reception (DRX) configuration and a lower-power wake-up signal (LPWUS) configuration, the DRX configuration comprising information for a timer associated with a DRX cycle, and the LPWUS configuration comprising information for a timer associated with physical downlink control channel (PDCCH) monitoring;
in a case where a LPWUS is received, starting the timer associated with PDCCH monitoring, wherein a DRX group is in active time while the timer associated with PDCCH monitoring is running; and
in a case where the DRX group is in active time, monitoring PDCCH.

21. The method of claim 20, further comprising: receiving a configuration for a time offset,
wherein the starting of the timer associated with PDCCH monitoring comprises: starting the timer associated with PDCCH monitoring at the time offset after reception of the LPWUS.

22. The method of claim 20, further comprising: transmitting assistance information, the assistance information comprising: a preferred time offset for LPWUS monitoring.

23. The method of claim 22, wherein, in a case where a prohibit timer is not running, starting the prohibit timer, and transmitting the assistance information.

24. The method of claim 20, wherein the terminal device is in a radio resource control (RRC) connected state.

25. A terminal device, comprising a processor configured to:
receive a discontinuous reception (DRX) configuration and a lower-power wake-up signal (LPWUS) configuration, the DRX configuration comprising information for a timer associated with a DRX cycle, and the LPWUS configuration comprising information for a timer associated with physical downlink control channel (PDCCH) monitoring;
in a case where a LPWUS is received, starting the timer associated with PDCCH monitoring, wherein a DRX group is in active time while the timer associated with PDCCH monitoring is running; and
in a case where the DRX group is in active time, monitoring PDCCH.

26. The terminal device of claim 25, wherein the processor is further configured to cause the terminal device to:
receive a configuration for a time offset,
wherein the starting of the timer associated with PDCCH monitoring comprises: starting the timer associated with PDCCH monitoring at the time offset after reception of the LPWUS.

27. The terminal device of claim 25, wherein the processor is further configured to cause the terminal device to:
transmit assistance information, the assistance information comprising: a preferred time offset for LPWUS monitoring.

28. The terminal device of claim 27, wherein, in a case where a prohibit timer is not running, starting the prohibit timer, and transmitting the assistance information.

29. The terminal device of claim 25, wherein the terminal device is in a radio resource control (RRC) connected state.
